(19) United States
(12) Patent Application Publication
(10) Pub. No.: US 2013/0016242 A1
(43) Pub. Date: Jan. 17, 2013

(54) ELECTRONIC CAMERA

(71) Applicant: Yoshifumi Mizuhara, Osaka-shi (JP)

(72) Inventor: Yoshifumi Mizuhara, Osaka-shi (JP)

(73) Assignee: SANYO ELECTRIC CO., LTD., OSAKA (JP)

(21) Appl. No.: 13/533,433

(22) Filed: Jun. 26, 2012

(30) Foreign Application Priority Data
Jul. 15, 2011 (JP) 2011-156541

(51) Int. Cl. H04N 5/225

(52) U.S. Cl. 348/222.1; 348/E07.085

(57) ABSTRACT

An electronic camera includes an imager. An imager outputs an image representing a scene. A searcher searches for an index image representing a specific index from the image outputted from the imager. A size adjuster adjusts a size of a material image to a size adapted to an appearance manner of the index image detected by the searcher. A composer executes a process of composing the material image having the size adjusted by the size adjuster on the image outputted from the imager, corresponding to a position of the index image detected by the searcher.

### CROSS REFERENCE OF RELATED APPLICATION

The disclosure of Japanese Patent Application No. 2011-156541, which was filed on Jul. 15, 2011, is incorporated herein by reference.

### BACKGROUND OF THE INVENTION

1. Field of the Invention

The present invention relates to an electronic camera, and in particular, relates to an electronic camera which composes a plurality of images.

2. Description of the Related Art

According to one example of this type of camera, a display screen displays a scene of a real world. An image capturing device captures image data that is associated with the display screen and representing the scene of the real world. An image-recognition logic circuit analyzes the image data representing the scene of the real world. An image-generation logic circuit adds an adding image in the scene of the real world, in response to the image-recognition logic circuit.

However, in the above-described camera, since it is not described how to add the adding image in the scene of the real world, it becomes probable that a composing manner becomes artificial, and therefore, an image processing performance may be deteriorated.

### SUMMARY OF THE INVENTION

An electronic camera according to the present invention comprises: an imager which outputs an image representing a scene; a searcher which searches for an index image representing a specific index from the image outputted from the imager; a size adjuster which adjusts a size of a material image to a size adapted to an appearance manner of the index image detected by the searcher; and a composer which executes a process of composing the material image having the size adjusted by the size adjuster on the image outputted from the imager, corresponding to a position of the index image detected by the searcher.

According to the present invention, an image processing program recorded on a non-transitory recording medium in order to control an electronic camera provided with an imager which outputs an image representing a scene and a searcher which searches for an index image representing a specific index from the image outputted from the imager, the program causing a processor of the electronic camera to perform the steps comprises: a size adjusting step of adjusting a size of a material image to a size adapted to an appearance manner of the index image detected by the searcher; and a composing step of executing a process of composing the material image having the size adjusted by the size adjusting step on the image outputted from the imager, corresponding to a position of the index image detected by the searcher.

According to the present invention, an image processing method executed by an electronic camera provided with an imager which outputs an image representing a scene and a searcher which searches for an index image representing a specific index from the image outputted from the imager, comprises: a size adjusting step of adjusting a size of a material image to a size adapted to an appearance manner of the index image detected by the searcher; and a composing step of executing a process of composing the material image having the size adjusted by the size adjusting step on the image outputted from the imager, corresponding to a position of the index image detected by the searcher.

The above described features and advantages of the present invention will become more apparent from the following detailed description of the embodiment when taken in conjunction with the accompanying drawings.

### BRIEF DESCRIPTION OF THE DRAWINGS

FIG. 1 is a block diagram showing a basic configuration of one embodiment of the present invention;

FIG. 2 is a block diagram showing a configuration of one embodiment of the present invention;

FIG. 3 is an illustrative view showing one example of a mapping state of an SDRAM applied to the embodiment in FIG. 2;

FIG. 4 is an illustrative view showing one example of an assignment state of an evaluation area in an imaging surface;

FIG. 5 is an illustrative view showing one example of a configuration of a register referred to in an imaging task and a continuous AF task;

FIG. 6 is a block diagram showing one example of a configuration of a recognition-mark detecting circuit;

FIG. 7 is an illustrative view showing one example of a configuration of a dictionary referred to by the recognition-mark detecting circuit;

FIG. 8 is an illustrative view showing one example of a recognition mark applied to the embodiment in FIG. 2;

FIG. 9 is an illustrative view showing one example of behavior of the recognition-mark detecting circuit;

FIG. 10 is an illustrative view showing one example of a configuration of a register referred to by the recognition-mark detecting circuit;

FIG. 11 is an illustrative view showing one example of a detection frame structure used by the recognition-mark detecting circuit;

FIG. 12 (A) is an illustrative view showing one example of an AR image;

FIG. 12 (B) is an illustrative view showing another example of the AR image;

FIG. 12 (C) is an illustrative view showing still another example of the AR image;

FIG. 12 (D) is an illustrative view showing yet another example of the AR image;

FIG. 13 is an illustrative view showing one example of a recognition-mark card applied to the embodiment in FIG. 2;

FIG. 14 (A) is an illustrative view showing one example of a size adjusting process for the AR image;

FIG. 14 (B) is an illustrative view showing another example of the size adjusting process for the AR image;

FIG. 14 (C) is an illustrative view showing still another example of the size adjusting process for the AR image;

FIG. 15 is an illustrative view showing one example of behavior of an image composing process for display;

FIG. 16 is an illustrative view showing one example of a composed image for record;

FIG. 17 is a flowchart showing one portion of behavior of a CPU applied to the embodiment in FIG. 2;

FIG. 18 is a flowchart showing another portion of behavior of the CPU applied to the embodiment in FIG. 2;

FIG. 19 is a flowchart showing still another portion of behavior of the CPU applied to the embodiment in FIG. 2;

FIG. 20 is a flowchart showing yet another portion of behavior of the CPU applied to the embodiment in FIG. 2;

FIG. 21 is a flowchart showing another portion of behavior of the CPU applied to the embodiment in FIG. 2; and

FIG. 22 is a block diagram showing a basic configuration of another embodiment of the present invention.

### DETAILED DESCRIPTION OF THE PREFERRED EMBODIMENTS

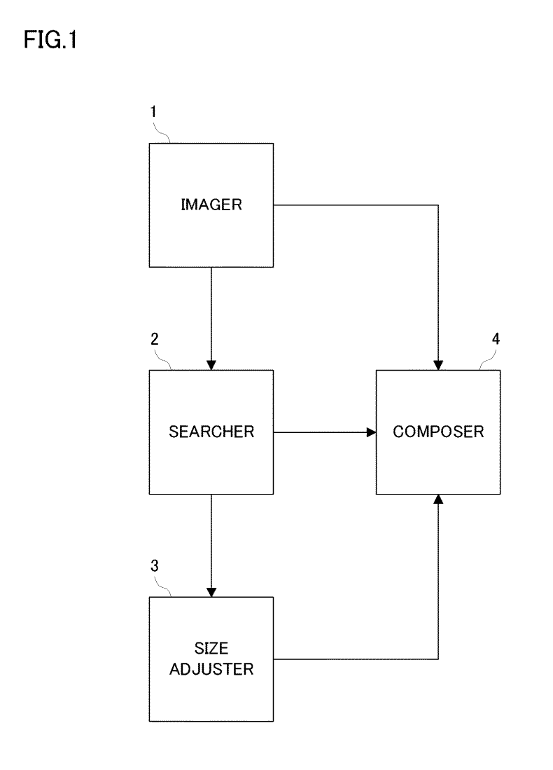

With reference to FIG. 1, an electronic camera according to one embodiment of the present invention is basically configured as follows: An imager 1 outputs an image representing a scene. A searcher 2 searches for an index image representing a specific index from the image outputted from the imager 1. A size adjuster 3 adjusts a size of a material image to a size adapted to an appearance manner of the index image detected by the searcher 2. A composer 4 executes a process of composing the material image having the size adjusted by the size adjuster 3 on the image outputted from the imager 1, corresponding to a position of the index image detected by the searcher 2.

The index image is searched from the image representing the scene outputted from the imager 1, and the size of the material image is adjusted based on the appearance manner of the detected index image. The material image of which size is thus adjusted and the image outputted from the imager 1 are composed corresponding to the position of the detected index image. The size of the material image is adjusted based on the appearance manner of the detected index image, and therefore, it becomes possible to compose the image representing the scene and the material image in a natural manner and improve an image processing performance.

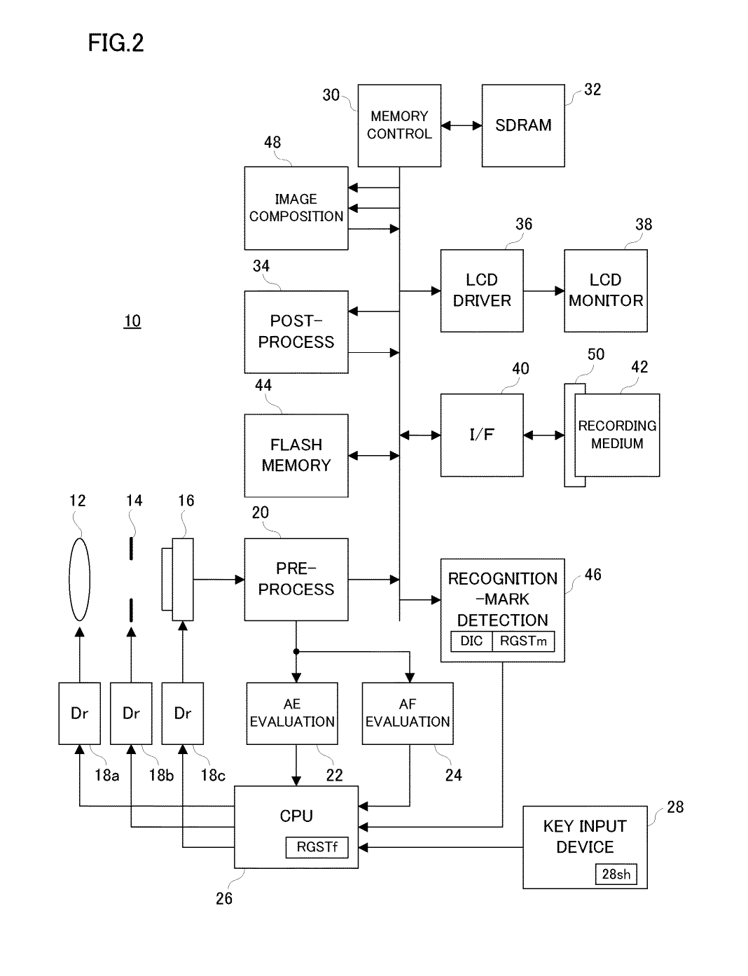

With reference to FIG. 2, a digital camera 10 according to one embodiment includes a focus lens 12 and an aperture unit 14 driven by drivers 18a and 18b, respectively. An optical image of a scene that underwent these components enters, with irradiation, an imaging surface of an image sensor 16, and is subjected to a photoelectric conversion. Thereby, electric charges corresponding to the scene captured by the image sensor 16 are produced.

The digital camera 10 has two imaging modes of an AR (augmented reality) mode for composing an AR image and a taken image and a normal mode. Each of the two imaging modes is mutually switched by an operator operating a key input device 28.

When a power source is applied, in order to execute a moving-image taking process, a CPU 26 commands a driver 18c to repeat an exposure procedure and an electric-charge reading-out procedure under an imaging task In response to a vertical synchronization signal Vsync periodically generated from an SG (Signal Generator) not shown, the driver 18c exposes the imaging surface of the image sensor 16 and reads out the electric charges produced on the imaging surface of the image sensor 16 in a raster scanning manner. From the image sensor 16, raw image data that is based on the read-out electric charges is cyclically outputted.

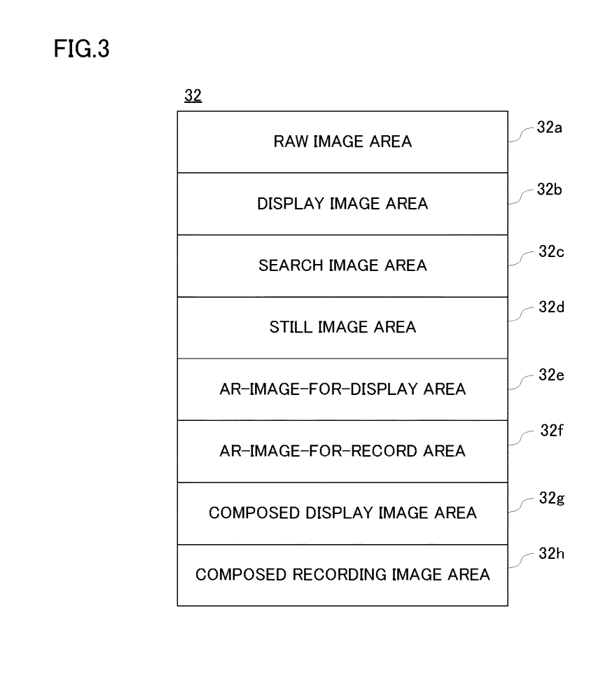

A pre-processing circuit 20 performs processes, such as digital clamp, pixel defect correction, gain control and etc., on the raw image data outputted from the image sensor 16. The raw image data on which these processes are performed is written into a raw image area 32a of an SDRAM 32 shown in FIG. 3 through a memory control circuit 30.

A post-processing circuit 34 reads out the raw image data stored in the raw image area 32a through the memory control circuit 30, and performs a color separation process, a white balance adjusting process and a YUV converting process, on the read-out raw image data. Furthermore, the post-processing circuit 34 executes a zoom process for display and a zoom process for search to image data that comply with a YUV format, in a parallel manner. As a result, display image data and search image data that comply with the YUV format is individually created. The display image data is written into a display image area 32b of the SDRAM 32 shown in FIG. 3 by the memory control circuit 30. The search image data is written into a search image area 32c of the SDRAM 32 shown in FIG. 3 by the memory control circuit 30.

An LCD driver 36 repeatedly reads out the display image data stored in the display image area 32b through the memory control circuit 30, and drives an LCD monitor 38 based on the read-out image data. As a result, a real-time moving image (a live view image) representing the scene is displayed on the LCD monitor 38.

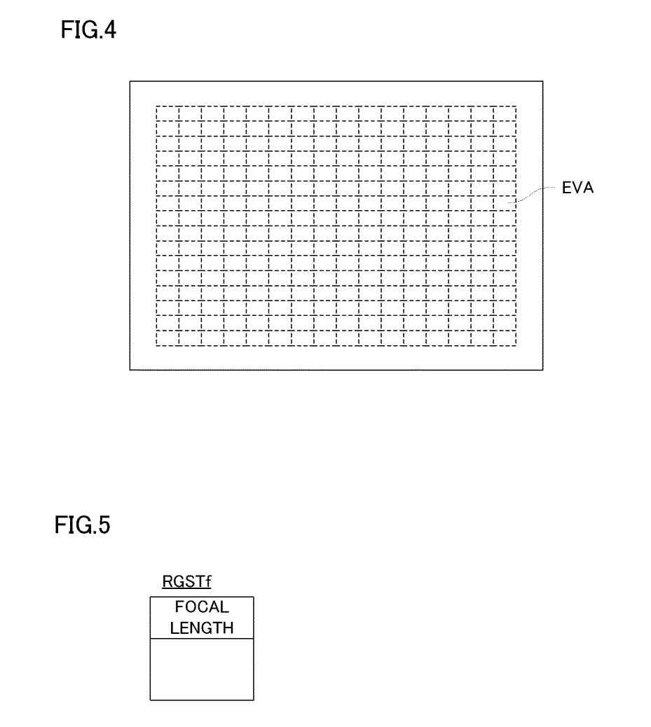

With reference to FIG. 4, an evaluation area EVA is assigned to a center of the imaging surface of the image sensor 16. The evaluation area EVA is divided into 16 portions in each of a horizontal direction and a vertical direction; therefore, 256 divided areas form the evaluation area EVA. Moreover, in addition to the above-described processes, the pre-processing circuit 20 shown in FIG. 2 executes a simple RGB converting process which simply converts the raw image data into RGB data.

An AE evaluating circuit 22 integrates RGB data belonging to the evaluation area EVA, out of the RGB data produced by the pre-processing circuit 20, at every time the vertical synchronization signal Vsync is generated. Thereby, 256 integral values (256 AE evaluation values) are outputted from the AE evaluating circuit 22 in response to the vertical synchronization signal Vsync.

An AF evaluating circuit 24 integrates a high-frequency component of the RGB data belonging to the evaluation area EVA, out of the RGB data generated by the pre-processing circuit 20, at every time the vertical synchronization signal Vsync is generated. Thereby, 256 integral values (256 AF evaluation values) are outputted from the AF evaluating circuit 24 in response to the vertical synchronization signal Vsync.

When a shutter button 28sh is in a non-operated state, the main CPU 26 executes a simple AE process that is based on output from the AE evaluating circuit 22 so as to calculate an appropriate EV value. An aperture amount and an exposure time period that define the calculated appropriate EV value are set to the drivers 18b and 18c, respectively. As a result, a brightness of a live view image is adjusted approximately.

In parallel with the moving-image taking process, the CPU 26 repeatedly issues a searching request toward a recognition-mark detecting circuit 46 in response to the vertical synchronization signal Vsync.

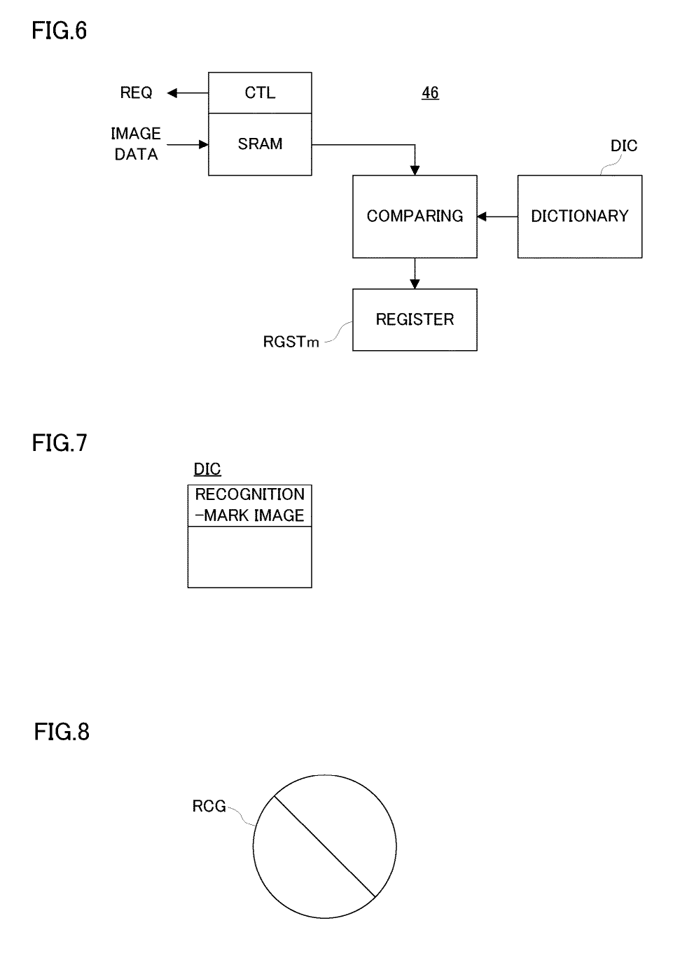

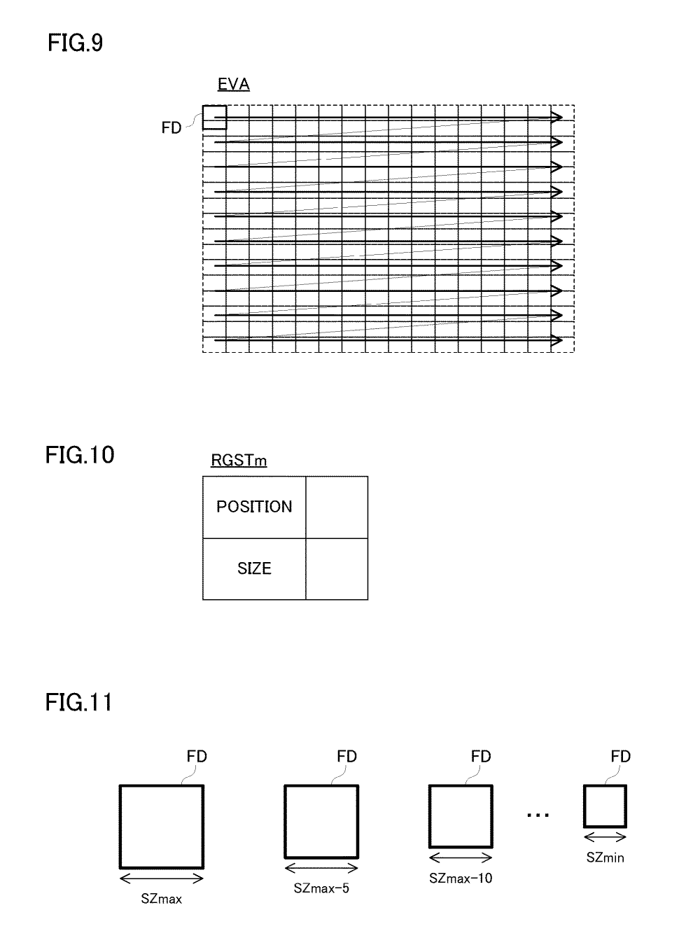

The recognition-mark detecting circuit 46 is configured as shown in FIG. 6. With reference to FIG. 7, a recognition-mark image RCG shown in FIG. 8 is contained in a dictionary DIC. The recognition-mark detecting circuit 46 moves a detection frame structure FD in a raster scanning manner from a head position of a search image stored in the search image area 32c toward a tail end position thereof (see FIG. 9) so as to compare a partial image belonging to the detection frame structure FD with the recognition-mark image RCG registered in the dictionary DIC.

When the image in the detection frame structure FD coincides with the recognition-mark image RCG, the recognition-mark detecting circuit 46 registers a position and a size of the detection frame structure FD at a current time point on a recognition-mark register RGSTm shown in FIG. 10. The registered position and size of the detection frame structure FD is respectively regarded as a position and a size of the recognition-mark image RCG.

The detection frame structure FD is reduced at every time reaching the tail end position (see FIG. 11), and is set again to the head position thereafter. Thereby, detection frame structures FD, FD, FD, . . . having mutually different sizes are scanned on a scene image in a raster direction. When a detection frame structure FD of a minimum size reaches the tail end position, a searching end notification is sent back from the recognition-mark detecting circuit 46 toward the CPU 26.

In response to the searching end notification sent back from the recognition-mark detecting circuit 46, the CPU 26 determines whether or not the recognition-mark image has been detected. When there is any registration in the recognition-mark register RGSTm, it is determined that the recognition-mark image has been detected. In contrary, when there is no registration in the recognition-mark register RGSTm, it is determined that the recognition-mark image RCG has not been detected.

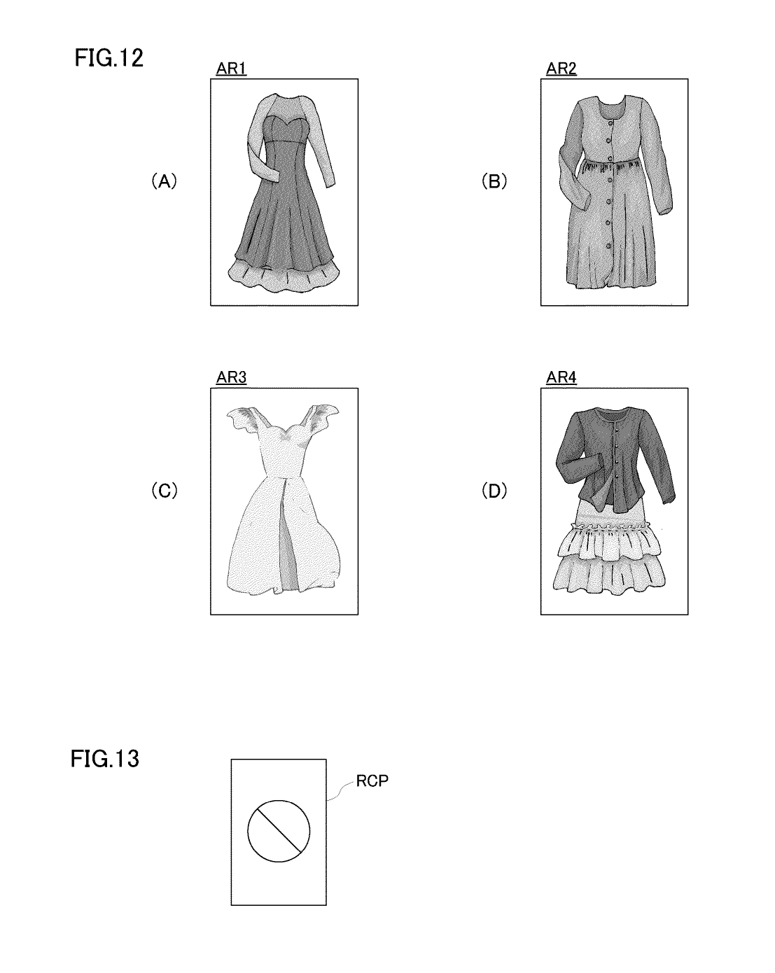

When the imaging mode is set to the AR mode and the recognition-mark image has been detected, the CPU 26 executes a process of adjusting a size of an AR image. The AR image is an image which is composed on the taken image, and for example, images of clothes for women, etc., may be used as AR images AR1 to AR4 respectively shown in FIG. 12 (A) to FIG. 12 (D). These AR images are stored in a recording medium 42 as AR image data, and any of AR images is previously selected as an image planned to be composed, by the operator operating the key input device 28.

It is noted that the recording medium 42 is detachable, and is accessed by an I/F 40 when being attached to a slot 50.

Moreover, under a continuous AF task parallel with a live-view image process, the CPU 26 repeatedly executes an AF process for a live view image that is based on output from the AF evaluating circuit 24.

When the recognition-mark image is not detected, the CPU 26 executes an AF process for a live view image in which a center of the scene is noticed. The CPU 26 extracts, out of the 256 AF evaluation values outputted from the AF evaluating circuit 24, AF evaluation values corresponding to a predetermined region of the center of the scene, and executes an AF process that is based on the extracted partial AF evaluation values. As a result, the focus lens 12 is placed at a focal point in which the center of the scene is noticed, and thereby, a sharpness of a live view image is continuously improved.

When the recognition-mark image has been detected, the CPU 26 executes an AF process in which the recognition-mark image is noticed. The CPU 26 extracts, out of the 256 AF evaluation values outputted from the AF evaluating circuit 24, AF evaluation values corresponding to the position and size registered in the recognition-mark register RGSTm, and executes an AF process that is based on the extracted partial AF evaluation values. As a result, the focus lens 12 is placed at a focal point in which the recognition-mark image is noticed, and thereby, a sharpness of the recognition-mark image in a live view image is improved.

A focal length that is based on a position of the focus lens 12 after completion of the AF process for a live view image is registered in a focal length register RGSTf shown in FIG. 5.

Upon composing the taken image and the AR image, used is a recognition-mark card RCP on which the recognition-mark image RCG is printed (see FIG. 13). The operator puts the recognition-mark card RCP on a place on which the AR image is desired to be composed in an imaged scene, or gives a subject person the recognition-mark card RCP to hold it in his/her hands.

In the process of adjusting the size of the AR image, the CPU 26 reads out the focal length registered in the focal length register RGSTf so as to calculate a subject distance corresponding to the read-out focal length. As a result of the AF process for a live view image being executed under the continuous AF task, when the recognition-mark card RCP exists in the imaged scene, the focal length is set to a distance that is based on a position of the recognition-mark card RCP. That is, the calculated subject distance indicates a distance between the digital camera 10 and the recognition-mark card RCP.

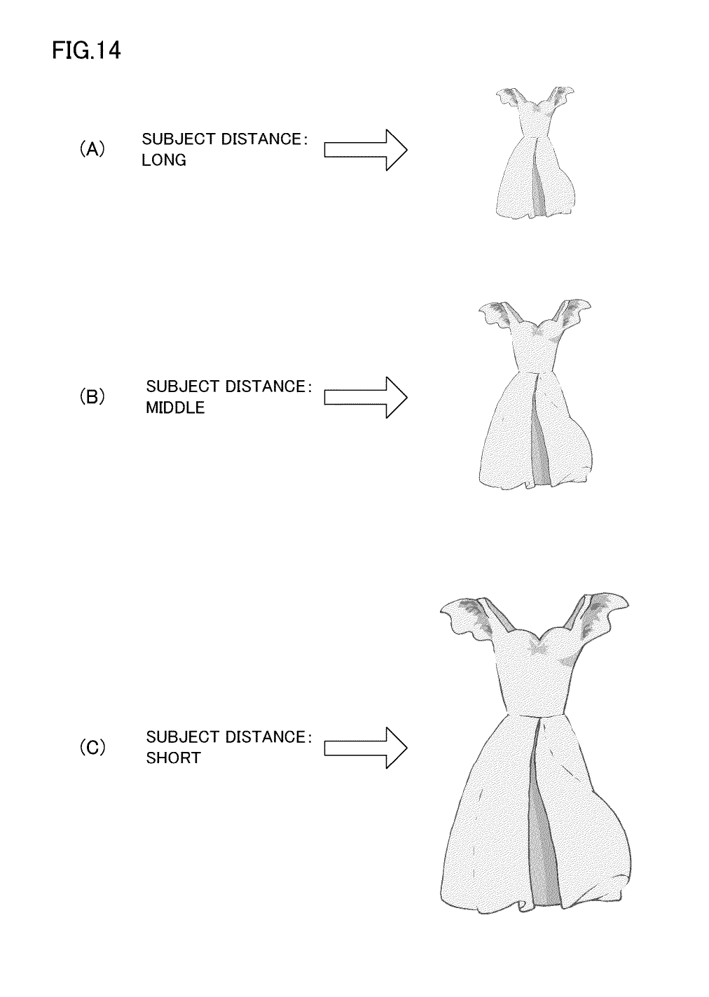

Based on the subject distance thus calculated, the CPU 26 executes a process of adjusting the size of the AR image to a size for display. With reference to FIG. 14 (A) to FIG. 14 (C), the CPU 26 adjusts the size of the AR image so as to become smaller as the subject distance becomes larger, and adjusts the size of the AR image so as to become larger as the subject distance becomes shorter. AR image data for display of which size is thus adjusted is stored in an AR-image-for-display area 32e shown in FIG. 3.

Moreover, the CPU 26 executes a process of adjusting the size of the AR image to a size for record. AR image data for record of which size is adjusted is stored in an AR-image-for-record area 32f shown in FIG. 3.

Upon completion of a size adjusting process, the CPU 26 reads out the position of the recognition-mark image RCG from the recognition-mark register RGSTm, and commands an image composing circuit 48 to compose the image for display.

The image composing circuit 48 repeatedly reads out the display image data from the display image area 32b through the memory control circuit 30, and repeatedly reads out the AR image data for display from the AR-image-for-display area 32e through the memory control circuit 30. A reading-out process from the display image area 32b and a reading-out process from the AR-image-for-display area 32e are executed in a parallel manner so as to input the display image data and the AR image data for display at the same time into the image composing circuit 48.

The image composing circuit 48 composes the inputted display image data and the AR image data for display to fit on the position of the recognition-mark image RCG, and therefore, composed display image data is created. The created composed display image data is written in to a composed display image area 32g of the SDRAM 32 through the memory control circuit 30.

The LCD driver 36 repeatedly reads out the composed display image data stored in the composed display image area 32g through the memory control circuit 30, and drives the LCD monitor 38 based on the read-out image data. As a result, the AR image is displayed on the LCD monitor 38 in a manner to be adapted to a position of the recognition-mark image RCG on a live view image and a distance to the recognition-mark card RCP.

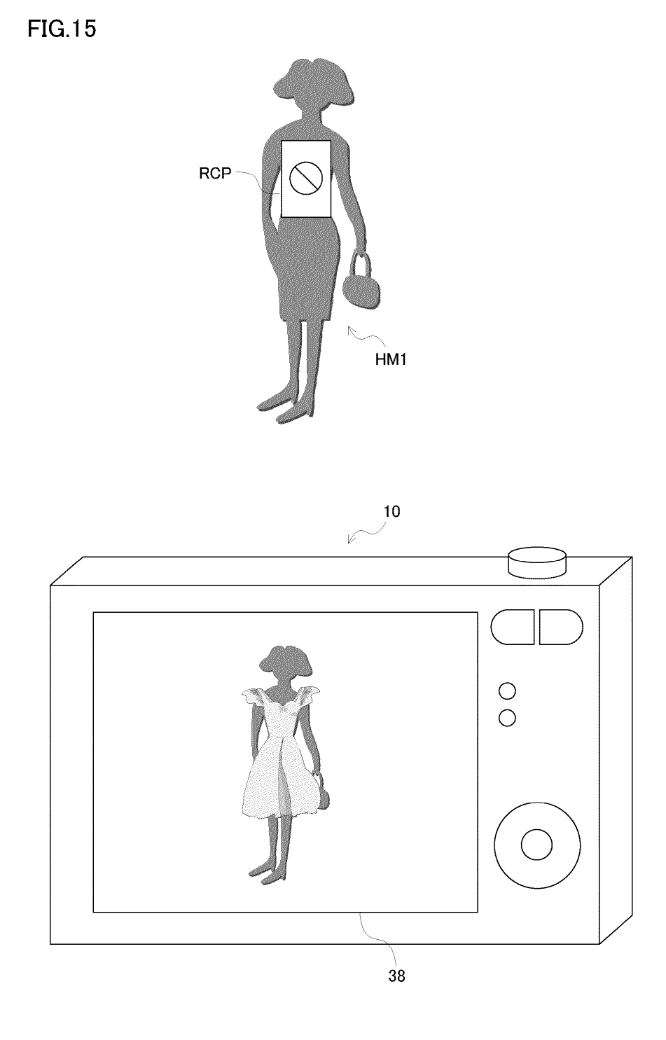

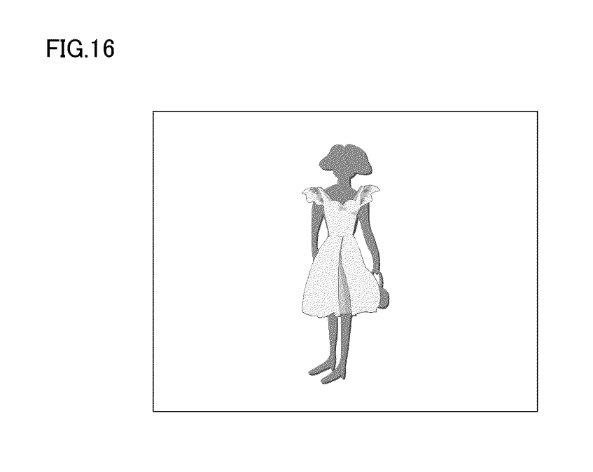

With reference to FIG. 15, when a person HM1 who holds up the recognition-mark card RCP is captured on the imaging surface of the image sensor 16, the AR image is displayed on the LCD monitor 38 in a manner to be composed on a live view image.

When the imaging mode is switched from the AR mode to the normal mode, or when the recognition-mark image is not detected, the CPU 26 commands the LCD driver 36 and the image composing circuit 48 to stop a composite display. As a result, the display of the LCD 38 returns to a display of only the live view image.

Moreover, the CPU 26 clears the AR image data for display and the AR image data for record respectively stored in the AR-image-for-display area 32e and the AR-image-for-record area 32f.

When a shutter button 28s is half-depressed, the CPU 26 interrupts the continuous AF task, and executes an AF process for record under the imaging task. Also the AF process for record is executed based on the output of the AF evaluating circuit 24. Thereby, a focus is adjusted strictly. Subsequently, the CPU 26 executes an AE process for record based on output of the AE evaluating circuit 22 so as to calculate an optimal EV value. Similar to the case described above, an aperture amount and an exposure time period that define the calculated optimal EV value are set to the drivers 18b and 18c, respectively. As a result, a brightness of a live view image is adjusted strictly.

When the shutter button 28sh is fully depressed, the CPU 26 executes a still-image taking process and a recording process under the imaging task One frame of the raw image data at a time point at which the shutter button 28sh is fully depressed is taken into a still image area 32d of the SDRAM 32 shown in FIG. 3, by the still-image taking process.

When the AR image data for record is not stored in the AR-image-for-record area 32f of the SDRAM 32, the taken one frame of the raw image data is read out from the still image area 32d by the I/F 40 activated in association with the recording process, and is recorded on the recording medium 42 in a file format

On the other hand, when the AR image data for record is stored in the AR-image-for-record area 32f, the CPU 26 reads out the position of the recognition-mark image RCG from the recognition-mark register RGSTm, and commands the image composing circuit 48 to start image composing for display.

The image composing circuit 48 reads out the taken one frame of the raw image data from the still image area 32d through the memory control circuit 30, and reads out the AR image data for record from the AR-image-for-record area 32f through the memory control circuit 30.

The image composing circuit 48 composes the read-out raw image data and the AR image data for record to fit on the position of the recognition-mark image RCG, and therefore, composed recording image data is created. The created composed recording image data is written in to a composed recording image area 32h of the SDRAM 32 through the memory control circuit 30. Moreover, the created composed recording image data is read out from the composed recording image area 32h by the I/F 40 activated in association with the recording process, and is recorded on the recording medium 42 in a file format.

In an example shown in FIG. 15, when the shutter button 28sh is fully depressed while the AR image is displayed on the LCD monitor 38 in a manner to be composed on a live view image, image data storing a composed image of the taken image and the AR image is recorded on the recording medium 42, as in an example shown in FIG. 16.

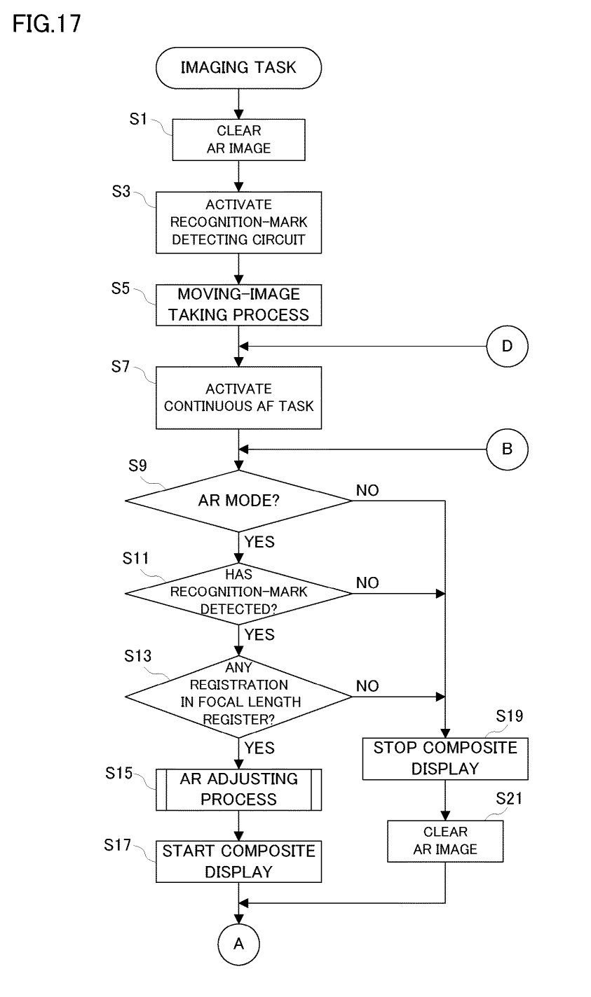

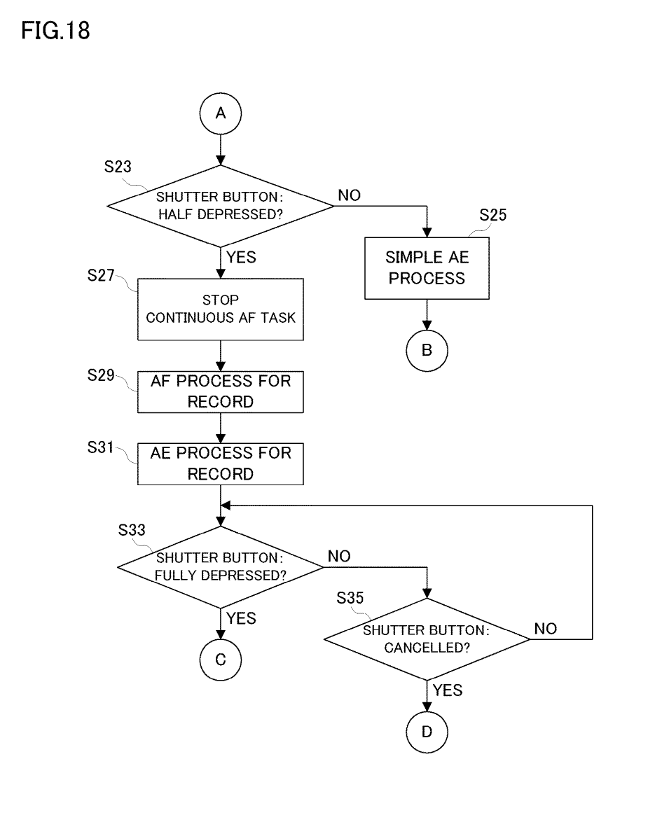

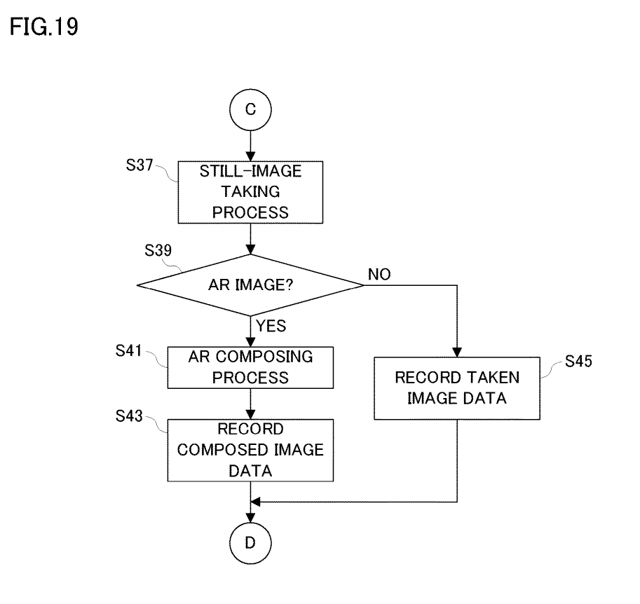

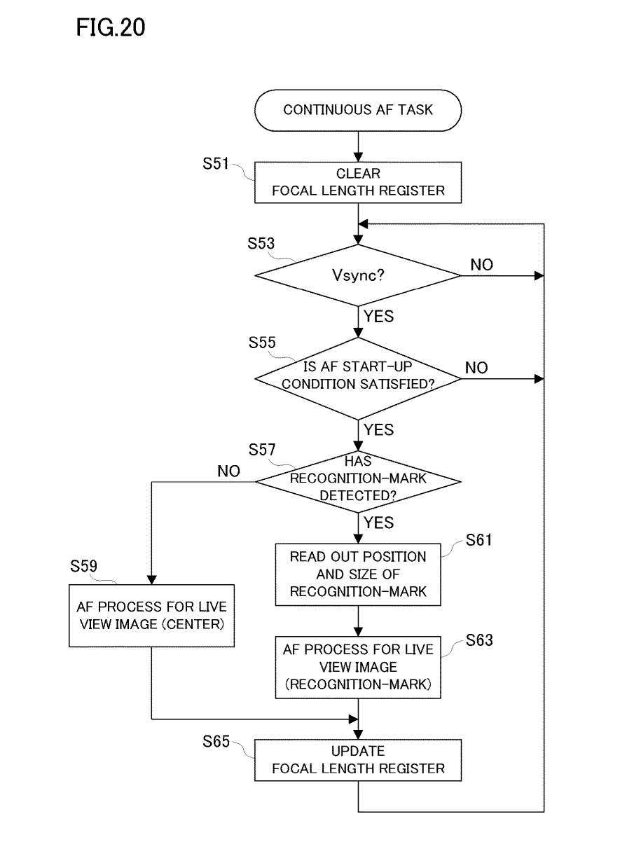

The CPU 26 executes a plurality of tasks including the imaging task shown in FIG. 17 to FIG. 19 and the continuous AF task shown in FIG. 20, in a parallel manner. It is noted that, control programs corresponding to these tasks are stored in a flash memory 44.

With reference FIG. 17, in a step S1, cleared are AR image data for display and AR image data for record respectively stored in the AR-image-for-display area 32e and the AR-image-for-record area 32f. In a step S3, the recognition-mark detecting circuit 46 is activated.

In a step S5, the moving-image taking process is executed. As a result, a live view image representing a scene is displayed on the LCD monitor 38. In a step S7, the continuous AF task is activated.

In a step S9, it is determined whether or not the imaging mode is set to the AR mode, and when a determined result is NO, the process advances to a step S19 whereas when the determined result is YES, in a step S11, it is determined whether or not a recognition-mark image is detected by the recognition-mark detecting circuit 46.

When a determined result of the step S11 is NO, the process advances to the step S19 whereas when the determined result of the step S11 is YES, in a step S13, it is determined whether or not a focal length is registered in the focal length register RGSTf.

When a determined result of the step S13 is NO, the process advances to the step S19, and when the determined result of the step S13 is YES, in a step S15, an AR adjusting process is executed in order to adjust a size of the AR image.

In a step S17, the LCD driver 36 and the image composing circuit 48 are commanded to start a composite display. As a result, the AR image is displayed on the LCD monitor 38 in a manner to be adapted to a position of the recognition-mark image RCG on a live view image and a distance to the recognition-mark card RCP.

In the step S19, the LCD driver 36 and the image composing circuit 48 are commanded to stop the composite display. As a result, the display of the LCD 38 returns to a display of only the live view image. In a step S21, cleared are the AR image data for display and the AR image data for record respectively stored in the AR-image-for-display area 32e and the AR-image-for-record area 32f.

Upon completion of the process in the step S17 or S21, in a step S23, it is determined whether or not the shutter button 28s is half-depressed, and when a determined result is YES, the process advances to a step S27 whereas when the determined result is NO, the process returns to the step S9 via a process in a step S25.

In the step S25, the simple AE process is executed. As a result, a brightness of a live view image is adjusted approximately.

In the step S27, the continuous AF task is stopped, and in a step S29, the AF process for record is executed. As a result, a focus is adjusted strictly. In a step S31, the AE process for record is executed. As a result, a brightness of a live view image is adjusted strictly.

In a step S33, it is determined whether or not the shutter button 28sh is fully depressed, and when a determined result is NO, in a step S35, it is determined whether or not the shutter button 28sh is cancelled. When a determined result of the step S35 is NO, the process returns to the step S33 whereas when the determined result of the step S35 is YES, the process returns to the step S7.

When the determined result of the step S33 is YES, in a step S37, the still-image taking process is executed. One frame of the raw image data at a time point at which the shutter button 28sh is fully depressed is taken into a still image area 32d of the SDRAM 32, by the still-image taking process.

In a step S39, it is determined whether or not the AR image data for record is stored in the AR-image-for-record area 32f of the SDRAM 32, and when a determined result is YES, the process returns to the step S7 via processes in a steps S41 and S43 whereas when the determined result is NO, the process returns to the step S7 via a process in a step S45.

In the step S41, the image composing circuit 48 is commanded to start image composing for display. As a result, composed recording image data of the raw image data and the AR image data for record is created, and the created composed recording image data is written in to the composed recording image area 32h of the SDRAM 32 through the memory control circuit 30.

In the step S43, the recording process for the composed image data is executed. As a result, the composed recording image data created in the step S41 is read out from the composed recording image area 32h by the I/F 40 activated in association with the recording process, and is recorded on the recording medium 42 in a file format.

In the step S45, the recording process for the taken image data is executed. As a result, one frame of the raw image data taken in the step S37 is read out from the still image area 32d by the I/F 40 activated in association with the recording process, and is recorded on the recording medium 42 in a file format.

With reference to FIG. 20, in a step S51, a registration content of the focal length register RGSTf is cleared, and in a step S53, it is repeatedly determined whether or not the vertical synchronization signal Vsync is generated. When a determined result is updated from NO to YES, in a step S55, it is determined whether or not an AF start-up condition is satisfied.

When a determined result of the step S55 is NO, the process returns to the step S53 whereas when the determined result of the step S55 is YES, in a step S57, it is determined whether or not the recognition-mark image has been detected. When a determined result of the step S57 is NO, the process advances to a step S65 via a process in a step S59 whereas when the determined result of the step S57 is YES, the process advances to the step S65 via processes in steps S61 and S63.

In the step S59, executed is the AF process for a live view image in which a center of the scene is noticed. As a result, the focus lens 12 is placed at a focal point in which the center of the scene is noticed, and thereby, a sharpness of a live view image is continuously improved.

In the step S61, the position and size registered in the recognition-mark register RGSTm are read out, and in the step S63, the AF process in which the recognition-mark image is noticed is executed based on the read-out position and size. As a result, the focus lens 12 is placed at a focal point in which the recognition-mark image is noticed, and thereby, a sharpness of the recognition-mark image in a live view image is improved.

In the step S65, a focal length that is based on a position of the focus lens 12 after completion of the AF process for a live view image is registered in the focal length register RGSTf. Upon completion of the process in the step S65, the process returns to the step S53.

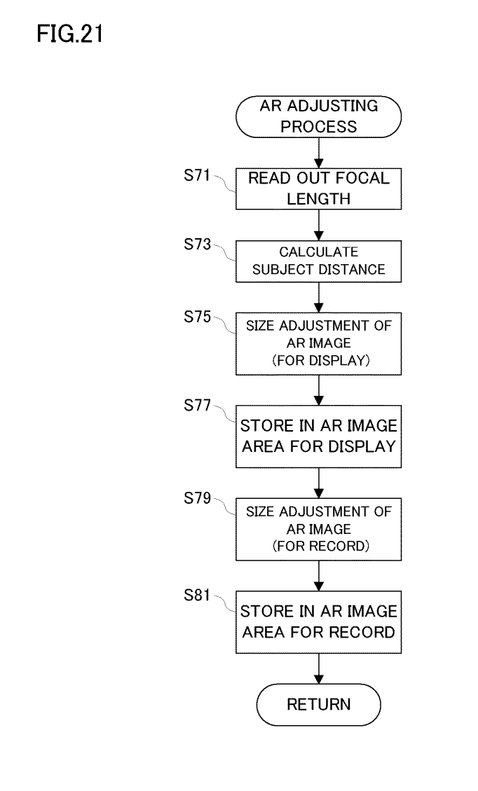

The AR adjusting process in the step S15 is executed according to a subroutine shown in FIG. 21. In a step S71, the focal length registered in the focal length register RGSTf is read out, and in a step S73, a subject distance corresponding to the read-out focal length is calculated.

In a step S75, the process of adjusting the size of the AR image to a resolution for display is executed based on the subject distance thus calculated. In a step S77, the AR image data for display of which size is adjusted is stored in the AR-image-for-display area 32e of the SDRAM 32.

In a step S79, the process of adjusting the size of the AR image to a resolution for record is executed based on the calculated subject distance. In a step S81, the AR image data for record of which size is adjusted is stored in the AR-image-for-record area 32f of the SDRAM 32. Upon completion of the step S81, the process returns to the routine in an upper hierarchy.

As can be seen from the above described explanation, the image sensor 16 outputs the image representing the scene. The recognition-mark detecting circuit 46 searches for the index image representing the specific index from the image outputted from the image sensor 16. The CPU 26 adjusts the size of the material image to the size adapted to the appearance manner of the index image detected by the recognition-mark detecting circuit 46. Moreover, the CPU 26 executes the process of composing the material image having the adjusted size on the image outputted from the image sensor 16, corresponding to the position of the index image detected by the recognition-mark detecting circuit 46.

The index image is searched from the image representing the scene outputted from the image sensor 16, and the size of the material image is adjusted based on the appearance manner of the detected index image. The material image of which size is thus adjusted and the image outputted from the image sensor 16 are composed corresponding to the position of the detected index image. The size of the material image is adjusted based on the appearance manner of the detected index image, and therefore, it becomes possible to compose the image representing the scene and the material image in a natural manner and improve an image processing performance.

It is noted that, in this embodiment, the subject distance is calculated from the focal length, and the size of the AR image is adjusted based on the calculated subject distance. However, the size of the AR image may be adjusted by another method. For example, the size of the AR image may be adjusted based on the size of the detected recognition-mark image RCG.

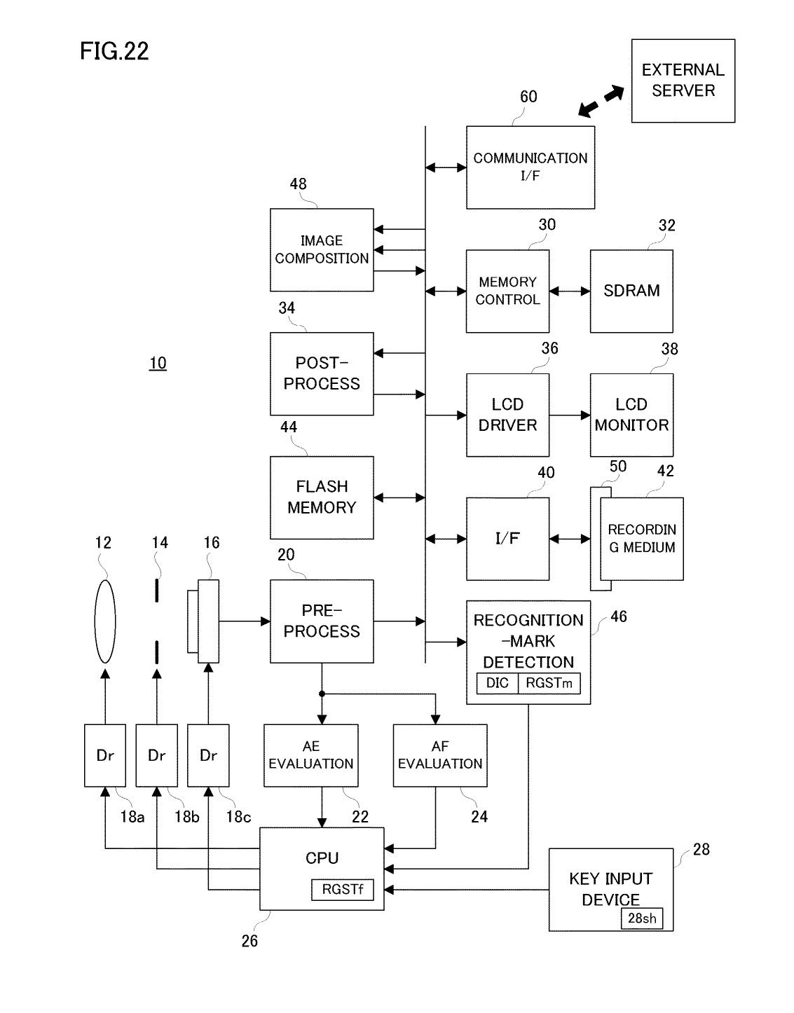

Moreover, in this embodiment, the control programs equivalent to the multi task operating system and the plurality of tasks executed thereby are previously stored in the flash memory 44. However, a communication I/F 60 may be arranged in the digital camera 10 as shown in FIG. 22 so as to initially prepare a part of the control programs in the flash memory 44 as an internal control program whereas acquire another part of the control programs from an external server as an external control program. In this case, the above-described procedures are realized in cooperation with the internal control program and the external control program.

Moreover, in this embodiment, the processes executed by the CPU 26 are divided into a plurality of tasks including the imaging task shown in FIG. 17 to FIG. 19, and the continuous AF control task shown in FIG. 20. However, these tasks may be further divided into a plurality of small tasks, and furthermore, a part of the divided plurality of small tasks may be integrated into another task Moreover, when a transferring task is divided into the plurality of small tasks, the whole task or a part of the task may be acquired from the external server.

Moreover, in this embodiment, the present invention is explained by using a digital still camera, however, a digital video camera, cell phone units or a smartphone may be applied to.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. An electronic camera comprising:
an imager which outputs an image representing a scene;
a searcher which searches for an index image representing a specific index from the image outputted from said imager;
a size adjuster which adjusts a size of a material image to a size adapted to an appearance manner of the index image detected by said searcher; and
a composer which executes a process of composing the material image having the size adjusted by said size adjuster on the image outputted from said imager, corresponding to a position of the index image detected by said searcher.

2. The electronic camera according to claim 1, further comprising a distance adjuster which adjusts a distance from a focus lens to an imaging surface arranged on said imager, based on the image outputted from said imager, wherein said size adjuster includes a calculator which calculates a distance to the specific index noticed by said searcher, based on the distance adjusted by said distance adjuster, and a changer which changes the size of the material image based on the distance calculated by said calculator.

3. The electronic camera according to claim 2, wherein said distance adjuster executes an adjusting process based on the index image detected by said searcher.

4. The electronic camera according to claim 1, further comprising a converter which converts a size of the image outputted from said imager into a display size, wherein said size adjuster adjusts the size of the material image with reference to the display size.

5. The electronic camera according to claim 1, further comprising:
a holder which detachably holds a recording medium in which the material image is recorded; and
a reader which reads out the material image from the recording medium held by said holder.

6. An image processing program recorded on a non-transitory recording medium in order to control an electronic camera provided with an imager which outputs an image representing a scene and a searcher which searches for an index image representing a specific index from the image outputted from said imager, the program causing a processor of the electronic camera to perform the steps comprising:
a size adjusting step of adjusting a size of a material image to a size adapted to an appearance manner of the index image detected by said searcher; and
a composing step of executing a process of composing the material image having the size adjusted by said size adjusting step on the image outputted from said imager, corresponding to a position of the index image detected by said searcher.

7. An image processing method executed by an electronic camera provided with an imager which outputs an image representing a scene and a searcher which searches for an index image representing a specific index from the image outputted from said imager, comprising:
a size adjusting step of adjusting a size of a material image to a size adapted to an appearance manner of the index image detected by said searcher; and
a composing step of executing a process of composing the material image having the size adjusted by said size adjusting step on the image outputted from said imager, corresponding to a position of the index image detected by said searcher.
